(19) United States
(12) Patent Application Publication
(10) Pub. No.: US 2008/0112581 A1
(43) Pub. Date: May 15, 2008

(54) Vibrating earphone with enhanced base sound effect

(76) Inventors: Stanley Kim, Upland, CA (US); Shyna Kim, Upland, CA (US)

Correspondence Address: Stanley Kim, 421 East 25th Street, Upland, CA, 91784, US

(21) Appl. No.: 11/595,188

(22) Filed: Nov. 9, 2006

(51) Int. Cl. H04R 25/00

(52) U.S. Cl. 381/151; 381/312

(57) ABSTRACT

A hearing device (FIG. 1, FIG. 2, FIG. 3) that simultaneously generates both air and bone conduction sounds. The vibrator (6) placed on mastoid bone can effectively produce enhanced bass sound effects.

This hearing device can be used for an hearing impaired person.

### CROSS-REFERENCE TO RELATED APPLICATION

None

### FEDERALLY SPONSORED RESEARCH

None

### SEQUENCE LISTINGS

None

### BACKGROUND

1. Field of the Invention

This invention relates to an earphone or headphone designed to enhance the effect of bass sound by a vibrating device in contact with the mastoid bone located just behind the ears.

2. Prior Art

As music playing devices, such as MP3 players, get smaller and more portable, the size of earphone or headphone have been reduced to make it easy to carry. Therefore, the size of the speaker installed in the earphone is also minimized. Some earphones with so-called ear-bud speaker are so small that they fit in the ear canal. Although an extremely small sized speaker may be able to generate a high frequency treble sound, it can not produce low frequency bass sounds very well because of the small size of speaker. In a high quality audio system, a woofer or subwoofer with a large speaker is used to produce good bass sound.

The sounds are conducted through both air and bone. High quality sound requires air conduction that transmits the sound signals to the cochlea through the ear by vibration of eardrum. The sound signals are eventually transmitted to the auditory nerve. However, one can still hear the sounds without functioning eardrums, such as in case of perforation of the eardrums, via bone conduction of the sounds. Vibration of the skull bone can conduct the sounds to the auditory nerve through the cochlea, but with much lower efficiency. Bone conduction devices have been developed mostly for the hearing impaired persons who cannot use air conduction, or for divers who need some communication under the water. A recently introduced waterproof MP3 player (manufactured by CS Ideas, Inc.) uses a transducer in contact with a cheekbone, which transmits the sound signals via bone conduction. In this device, the sounds are only conducted by bone. Recently, many vibrating headphones are marketed mainly for a video gamer who wants a vibrating sensation with low frequency sounds. Two types of such headphone exist: A headphone that wraps the whole ear, or an earphone using an ear-bud speaker placed in the outer ear canal that vibrates. In these devices, the whole speaker vibrates especially in low frequency sounds. It can not be said that the vibration of the speaker in the outer ear canal conduct the sounds purely by bone.

Disadvantages of these vibrating headphones are as followings:
1. These large vibrating headphones uses mostly air conduction in generating sounds. In their headphones, a separate speaker that vibrates is installed in addition to a regular micro-speaker in the same headphone case. Therefore, the sounds are directly transmitted to the eardrum mainly by air conduction. If the users want to feel loud bass sound and vibrations, the sound volume has to be increased across all frequencies. The loud sounds directly transmitted to the eardrums can cause hearing damages.
2. Vibrations occurring on the sensitive ear skin can cause ticklish sensation in the ear opening, especially by a small ear-bud shaped earphone placed on the outer ear canal. This can result in scratching the outer ear opening to cause potential outer ear infection.
3. A large headphone is difficult to carry for a traveler as it takes more space.

### BACKGROUND—OBJECTS AND ADVANTAGES

This device has a dual function in generating sounds by both air- and bone-conduction simultaneously. No portable headphone for a casual use using both air-and bone-conduction simultaneously is available. All the present headphones use either air or bone conduction. A loud speaker with bigger bass sounds transmitting sounds directly to the eardrum can damage user's hearing. A headphone mainly using bone conduction has inferior quality of sounds compared to one using air conduction. The sounds are muffled.

Therefore, a system using both air and bone conduction as well as capability to separately adjust the amplitudes of the sounds from air and bone conduction can overcome these problems.

This invention has a pair of 6 components;
1. An earphone piece with a micro-speaker that is plugged into the outer ear canal. This part generates sounds by mostly air conduction.
2. An hanging piece which is placed over the ear to keep the earphone piece from falling off.
3. A vibrating piece attached in the end of the hanging piece that is placed on the mastoid bone just behind the ears. The vibration-generated bone conduction sounds mimic the effect of a powerful woofer or subwoofer in a bigger audio system.
4. A jack plug with a wire string that connects the earphone piece and the vibrating piece to a sound generating device such as MP-3 or game machine.
5. A low pass filter unit that converts the low frequency sound signals to the vibrations while the high frequency sounds are filtered. It is programmed to correlate the amplitude of the sound waves with the magnitude of vibration. The bigger the amplitudes of the sound waves, the more vibrations generated by the device.
6. A power source unit with a battery.

With the above features, this device has following objects and advantages;
1. An ordinary micro speaker placed in the ear conducts the sound by mostly air, and the vibrator piece separately placed on the mastoid bone behind the ear conducts the sound by bone. Therefore, a user can enjoy simultaneously both ordinary air conducted quality treble sounds as well as the feeling of vibrations conducted via mastoid bone that mimic the enhanced bass effect. Because the strong bass sounds are mainly generated by bone-conduction through the vibrator, there is much less risk of damaging the hearing.
2. The vibrator is logistically placed on the mastoid bone behind the ear that locates near the cochlea, which can transmit the sound signals more efficiently. Therefore, the sounds, especially low frequency sounds, generated by the vibrator and transmitted via bone conduction can make a user feel very impressive bass effects.
3. The separate location of the vibrator from the ordinary micro-speaker reduces uncomfortable feeling by avoiding vibrations occurring directly on the outer ear canal. The commercially available vibrating earphones wiggle the whole speaker in the outer ear canal. This can tickle the sensitive ear skin, potentially resulting in outer ear infection by scratching.
4. In this embodiment, the vibrator is secured by placing in the end of the earphone hanging piece that keeps the earphone from falling. Therefore, it does not need other securing methods such as headband. It makes this device to be in a small size, and to be carried and worn easily.
5. It also has stereo effects as the each earphone has its own vibrator which receives the same sound signals from the sound generating device.
6. If the user does not want the strong vibrations, its amplitude can be adjusted. The sounds from air conduction and bone conduction can be separately adjusted by separately placed volume control units according to the user's preference.
7. This invention can be used wirelessly by a wireless transmission unit that can be attached in this device.
8. By installing a microphone and a small amplifier in this device it can be used for a hearing impaired person. The capability to amplify the sounds from the air conduction and bone conduction separately in both right and left side can make the hearing impaired person adjust the sounds according to their preference to maximize hearing and comfort. For example, a hearing impaired person can have ability to hear the bone conducted sounds in addition to the amplified air-conducted sounds. No portable hearing aid that utilizes both air and bone conduction simultaneously and that has a function to control the amplitudes of the sounds from air and bone conduction separately is available. The hearing impaired can also enjoy full stereo sounds.

### SUMMARY

The vibrating earphone with enhanced bass effects has a dual function of generating sounds by both air-conduction and bone-conduction simultaneously:
1. Ordinary high quality delicate sounds generated by air conduction from an earphone piece.
2. Bone conducted sounds via the vibrators placed on the mastoid bone which mimic the powerful bass effects.
3. The vibrating earphone can also be used by the wireless system without the connecting lines between the earphone to a music playing device by installing a wireless transmission unit.
4. This device also can be used for a hearing impaired person.

This invention has a pair of 6 components;
1. An earphone piece with a micro-speaker that is plugged into the outer ear canal. This part generates high quality delicate sounds by mostly air conduction.
2. An hanging piece which is placed over the ear to keep the earphone piece from falling off.
3. A vibrating piece using piezoelectric element attached in the end of the hanging
4. A jack plug with a wire string that connects the earphone piece and the vibrating device to a sound generating device such as MP-3 or game machine, computer, DVD machine, or etc.
5. A low pass filter unit that converts the low frequency sound signals to the vibrations while the high frequency sounds are filtered. A user can adjust the amplitude of air-conducted sound and bone-conducted sound frequencies separately to obtain the best effect and comfort. It is programmed to correlate the amplitude of the sound waves with the magnitude of vibration. The bigger the amplitudes of the sound waves, the more vibrations generated by the device.
6. A power source unit with a battery.

### DRAWINGS—FIGURES

FIG. 1 is a perspective view of a vibrating earphone with a separate vibrating device placed on the mastoid bone.

FIG. 2 is a perspective view of a vibrating earphone which shows the detailed components.

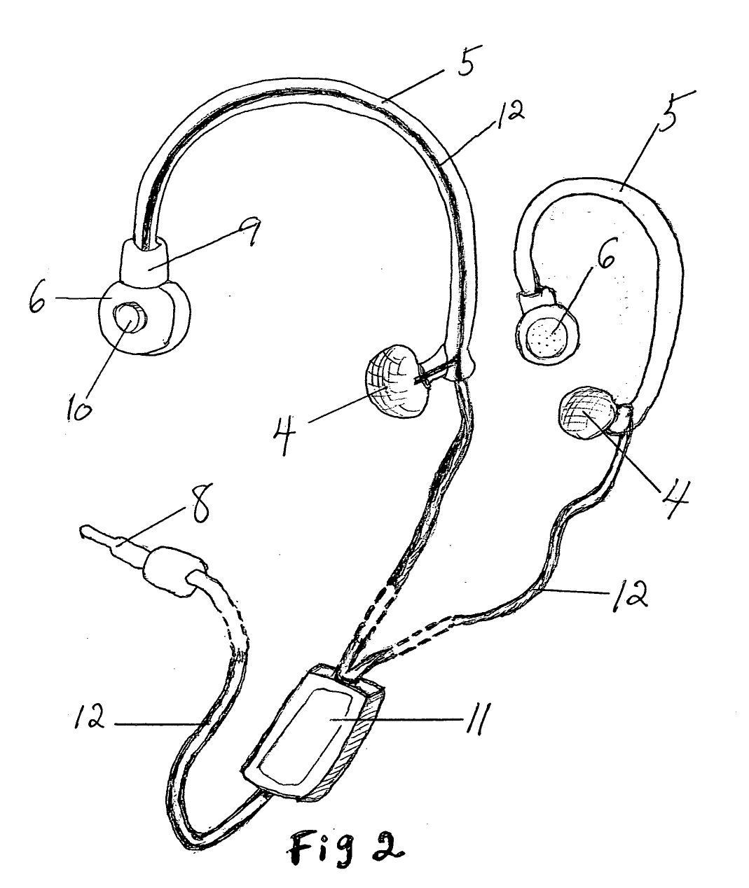

FIG. 3 is a perspective view of a vibrating earphone that has a different embodiment, in which the vibrator is placed on top of the skull bone.

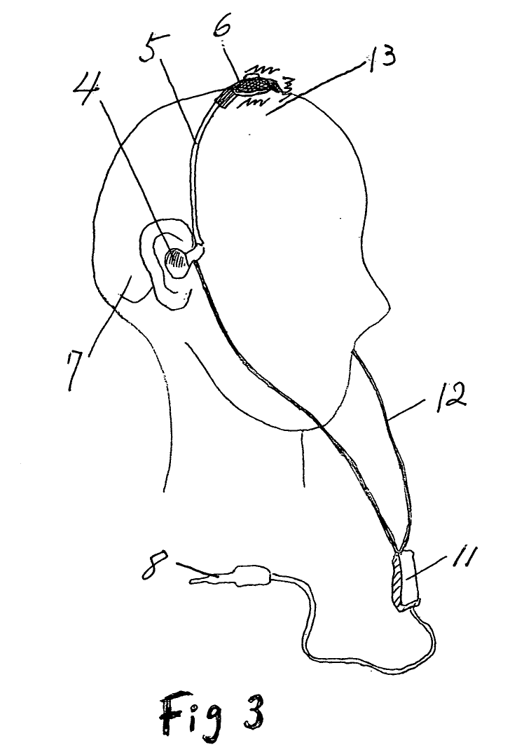

### DRAWINGS—REFERENCE NUMERALS

4. An earphone with a small speaker plugged in the outer ear canal.
5. An hanging piece placed over the ear.
6. A vibrating piece attached in the hanging piece
7. The mastoid bone.
8. A jack plug with a connecting wire line that is plugged into a music player device, such as MP-3.
9. A low pass filter unit for a vibrator with an adjustment device
10. A vibrator amplitude control unit.
11. A power source unit with a battery.
12. A connecting electric wire.
13. The top of the skull bone

### DETAILED DESCRIPTION

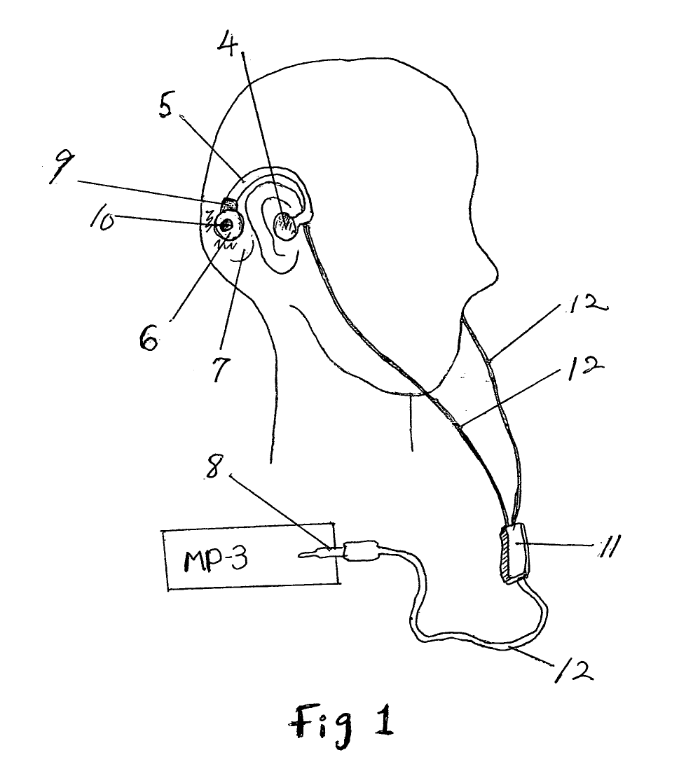

FIG. 1 is a perspective view of a vibrating earphone with enhanced bass effect. In this device, an ordinary ear-bud shaped earphone piece (4) is placed in the outer ear canal. A hook-shaped hanging piece (5) is attached to the earphone piece (4) in order to secure and to prevent it from falling off. A vibrating piece (6) is attached in the end of the hanging piece (5), and it is naturally placed on the mastoid bone (7) located just behind the ear. The above arrangement is repeated as a pair for the ear in the other side of the face.

At the other end of the earphone is a jack plug (8) which connects the earphone to a sound generating device such as a MP-3 player. The sound electric signals are transmitted by a connecting electric wire (12) to the micro-speaker in the ear-bud shaped earphone (4) as well as to the vibrator (6) which has a piezoelectric element. The piezoelectric element converts the electric sound signals to bone conduction signals by way of generating vibration. The electric sound signals have to pass a low filter unit (9) before they reach the piezoelectric element in the vibrator. The low filter unit allows the only desirable low frequency waves to pass and reach the piezoelectric element. Depending on the user's preference, the cut-off threshold of filtering is adjusted by an adjusting device installed in the low filter unit (9). The user not only feels the vibration but also hear much lower frequency sounds by way of bone conduction. For an hearing impaired person, this function of bone conduction is particularly useful to maximize the hearing capability.

A vibration amplitude control unit (10) attached in the vibrator can adjust the Strength of vibration. For a video gamer who wants excitement, more vibration can be generated with help of extra energy by power source unit with a battery (11).

### Operation

The ear-bud shaped earphones (4) are placed in the outer ear canal of both right and left ears. The hanging pieces (5) are hung over the upper auricles to secure the position of the earphone. The vibrating piece (6) attached in the end of the hanging piece is placed on the mastoid bone (7). Because the mastoid bone locates just behind the ear, the vibrating piece will be in contact with the mastoid bone naturally. The connecting plug (8) is plugged into a sound generating device such as MP-3, CD or DVD players, a video game machine, or computers, etc. When the sound generating device is turned on, the user can hear ordinary sound from the ear-bud earphone (4) having the micro-speaker.

Because of the very small sized speaker low frequency bass sounds are not well reproduced. At the same time the sound signals reach the piezoelectric element in the vibrator (9) which generated vibration from the electric sound signals. The user can feel the vibration occurring behind the ear, and can hear much better low frequency sounds by bone conduction. This vibrating piece will greatly enhances bass effect. The vibrator functions as a bone conduction speaker, and the vibrating sound signals travel to the cochlea through the bone. Then the sound signals will reach the auditory nerve.

Therefore, one can hear the sounds simultaneously from both air and bone conductions. Because of logistical proximity of the mastoid bone to the cochlea, the sounds conducted by bone this way should be much more efficient.

The low filter unit (9) allows certain low frequency sound signals pass to reach the piezoelectric element in the vibrating piece (6). Depending on user's preference, the filtering frequency can be adjusted by an adjuster installed in this unit. This function is very useful if this device is used for a hearing impaired person because not all the hearing impaired have same kind and extent of hearing defect. It can be adjusted to have the most comfortable level. In addition, the amplitude of the vibration can be adjusted by the vibrator amplitude control unit (10). For example, a video gamer wants strong vibration and bass effects via bone conduction, it can be amplified with help of extra energy by the battery powered unit (11). However, if the user wants quiet sounds, the volume adjuster of the sound generating device can be turned down.

I claim:

1. A hearing device that simultaneously generates both air-conducted sounds, and bone-conducted sounds with vibrations, comprising of:
(a) An air-conduction speaker or transducer placed in the ear or outer ear canal.
(b) A vibrator or bone-conduction transducer placed on the mastoid bone or other areas of bone in the head, such as top of the head, or jaw.
(c) Means for connecting said air-conduction transducer to said vibrator or bone-conduction transducer.
(d) Means for connecting said hearing device to a sound generating device, such as MP3, a video game machine, DVD and CD players, computers, TV, or others.
(e) Means for converting the electric sound signals to vibrations or bone-conduction signals, such as a piezoelectric system, or other methods.
(f) Means for supplying energy to support the functions of said hearing device.

2. The hearing device of claim 1, further including means for filtering the electric sound signals that allow desirable sound frequencies pass to reach said vibrator or bone conduction transducer.

3. The hearing device of claim 1, further including means for adjusting the amplitude of vibrations and the bone-conduction signals.

4. The hearing devices of claims 1, 2 and 3 wherein the components of said hearing device are made to have a stereo sound production.

5. The hearing devices of claim 4 wherein the components of said hearing device are made to produce a surrounding sound system production.

6. The hearing devices of claims 1,2,3,4 and 5 wherein said means for connecting the hearing devices to the sound generating devices having a wireless transmission unit that can connect said hearing devices to said sound generating devices wirelessly.

7. The hearing devices of claim 1, 2, 3, 4, 5 and 6, further including a microphone and an amplifier, which can be used for an hearing impaired person.

8. The hearing device of claim 7, further including means for controlling amplitudes of air-conducted and bone-conducted sounds separately in both right and left sides, thus enabling the hearing impaired to obtain optimal hearing capability at the most comfortable levels. This function is important for the hearing impaired because they all are different in types or degrees of their hearing defects. This function allows the hearing impaired to have customized setting of the hearing device.
